(19) United States
(12) Patent Application Publication
(10) Pub. No.: US 2025/0059047 A1
(43) Pub. Date: Feb. 20, 2025

(54) CONFINEMENT SILICON DIOXIDE/MULTI-WALLED CARBON NANOTUBE COMPOSITE MATERIAL,AND PREPARATION METHOD AND USE THEREFOR

(71) Applicant: WENZHOU UNIVERSITY, Wenzhou (CN)

(72) Inventors: Shun WANG, Wenzhou (CN); Huile JIN, Wenzhou (CN); Jun LI, Wenzhou (CN); Feng ZHOU, Wenzhou (CN); Huihang LU, Wenzhou (CN); Lijie ZHANG, Wenzhou (CN)

(73) Assignee: WENZHOU UNIVERSITY, Wenzhou (CN)

(21) Appl. No.: 18/723,501

(22) PCT Filed: Feb. 3, 2023
(86) PCT No.: PCT/CN2023/074376

§ 371 Date: Jun. 24, 2024

(30) Foreign Application Priority Data
Dec. 24, 2021 (CN) 202111598295.3

(51) Int. Cl. C01B 32/168

(52) U.S. Cl. CPC C01B 32/168; C01B 2202/06; C01B 2202/22; C01P 2004/133

(57) ABSTRACT

A confined silica/multi-walled carbon nanotube composite material, its preparation method, and application are provided. The preparation method includes the following steps: S1: dispersing multi-walled carbon nanotubes in a methyl-substituted benzene solvent and subjecting them to ultrasonication for 10 minutes at room temperature; S2: after the completion of ultrasonication, adding liquid silicon tetrachloride to the multi-walled carbon nanotube/xylene suspension and continuing ultrasonication for 10 minutes at room temperature; S3: heating the mixture in an oil bath to 145° C. and performing reflux; S4: after the reaction is complete, naturally cooling to room temperature, centrifuging, washing, and drying the obtained solid to obtain a dry sample, thereby obtaining the confined silica/multi-walled carbon nanotube composite material. The confined silica/multi-walled carbon nanotube composite material exhibits excellent rate capability and cycling stability, and has great application potential and industrial value.

### CROSS REFERENCE TO THE RELATED APPLICATIONS

This application is the national phase entry of International Application No. PCT/CN2023/074376, filed on Feb. 3, 2023, which is based upon and claims priority to Chinese Patent Application No. 202111598295.3, filed on Dec. 24, 2021, the entire contents of which are incorporated herein by reference.

### TECHNICAL FIELD

The present invention provides a method for preparing a confined silica/multi-walled carbon nanotube composite material for use as a negative electrode in lithium-ion batteries, as well as an electrode prepared from said material. Specifically, it offers a confined silica/multi-walled carbon nanotube composite material, its preparation method, applications, and the use of this material in preparing lithium-ion battery negative electrode materials. This invention falls within the field of new materials and electrochemical energy storage technology.

### BACKGROUND

In response to the global energy demand crisis and the climate change caused by the combustion of fossil fuels, electric vehicles, hybrid electric vehicles, and energy storage systems equipped with lithium-ion batteries are key to addressing sustainable development in human society. Currently, the commercially available negative electrode materials for lithium-ion batteries mainly consist of graphite, which is abundant, widely available, has low potential, and offers certain stability. However, its limited theoretical capacity (372 mAhg⁻¹) still cannot meet the continuously growing demands for battery energy density and specific capacity. For example, vehicles powered by lithium-ion batteries still cannot surpass the driving range of internal combustion engine vehicles (approximately 650 kilometers). Therefore, the development of high-capacity lithium-ion negative electrode battery materials is a crucial direction of current research.

So far, various high theoretical capacity active negative electrode materials have been proposed to replace graphite, such as silicon, tin, and germanium. Due to their high theoretical specific capacities (for instance, Liz₂Sis exhibits approximately 4200 mAhg⁻¹ specific capacity at 415° C., while LisSi₄ at room temperature shows 3579 mAhg⁻¹ specific capacity), relatively low redox voltages (<0.5 V vs Li/Li⁺), abundance, and environmental friendliness, silicon is considered a promising high-energy electrode material for lithium-ion batteries (LIBs). Silicon dioxide, as a type of silicon oxide, is considered an ideal material for silicon-based lithium-ion battery negative electrodes due to its abundant crustal reserves, low cost, high lithium storage capacity (1965 mAhg⁻¹), and low discharge potential. However, issues such as the intrinsic poor conductivity of silicon dioxide and the volume expansion during lithium extraction (approximately 200% volume expansion) remain challenges for the application of silicon dioxide in lithium-ion battery negative electrodes.

To address the drawbacks of poor conductivity and volume expansion of silicon dioxide (or silicon), composite materials of silicon dioxide (or silicon) and carbon have emerged as an effective solution. This method has been widely applied in lithium-ion battery negative electrode materials. For instance:

CN113178564A discloses a method for preparing silicon dioxide-carbon composite material and its application. The specific preparation method includes: Step 1. Immersing rice husks in a solution with a citric acid concentration of 3-9 wt %, controlling the temperature of the acidic solution to be between 30-70° C. for a certain period, rinsing the rice husks, and then drying them. Step 2. Grinding the dried rice husks obtained in step 1. Step 3. Under the protection of an inert gas, high-temperature calcination of the rice husk powder prepared in step 2 to obtain silicon dioxide-carbon composite material. This preparation method utilizes biomass rice husks as the source of silicon and carbon, thereby achieving the reuse of biomass materials to some extent and reducing the material sourcing cost. Although silicon dioxide-carbon composite materials demonstrate significant specific capacity and excellent cycling stability when used as lithium-ion battery negative electrode materials, the complex and environmentally unfriendly operations involved in the preparation process, such as acid washing and high-temperature calcination, remain challenging.

CN112599751A discloses a method for preparing a silicon dioxide/carbon composite material for the negative electrode of a lithium-ion battery, as well as its product and application. The specific steps of the preparation method are as follows: Step 1. Rice husks are thermally decomposed at 550° C., then treated with hydrofluoric acid, and the resulting product is washed and calcined to obtain pyrolyzed rice husks (PRH). Step 2. PRH is dispersed in a sodium hydroxide solution and heated and stirred at 50° C. for two hours. The incompletely ashed sample is separated by filtration, washed with water and ethanol, and then dried. Step 3. The sample prepared in step 2 is subjected to high-temperature calcination at 500° C. under an inert argon atmosphere for three hours. After pyrolysis, high-purity argon is replaced with argon containing water vapor for steam activation at 700° C. After the reaction, the silicon dioxide/carbon composite material is naturally cooled under argon protection.

CN108878813A discloses a method for preparing silicon dioxide/wood lignin porous carbon composite material for use in the negative electrode material of lithium-ion batteries. The specific steps are as follows: Step 1. Industrial wood lignin and additives (such as n-butanol, n-pentanol, etc.) are dissolved in ethanol to prepare a series of gradient concentration solutions with mass concentrations ranging from 5 to 20 g/L. Step 2. Nanoscale silicon dioxide is injected into the lignin/additive ethanol solution prepared in step 1. After uniform mixing, the mixture is added to a poor solvent water, and the silicon dioxide/lignin mixture precipitates. Step 3. The precipitate obtained in step 2 is added to an acidic solution with a pH of 2-4 to prepare a series of suspensions with different concentrations. The suspension is heated at 120-200° C. for one to three hours, and then the precipitate is filtered and dried. Step 4. The precipitate obtained in step 3 is subjected to high-temperature calcination, and after pyrolysis, the pyrolysis product is immersed in hydrofluoric acid, followed by acid washing, filtration, and drying to prepare the silicon dioxide/wood lignin porous carbon composite material.

CN111446440A discloses a nitrogen-doped carbon-coated hollow silicon dioxide/cobalt nanowire composite material for the negative electrode of a lithium-ion battery. The specific synthesis method is as follows: Step 1. Resorcinol is dripped into ammonia water, followed by adding a mixture of anhydrous ethanol/deionized water with a volume ratio of 3:4. Then, tetraethyl orthosilicate and hexadecyl trimethyl ammonium bromide are slowly added under stirring conditions. After drying and high-temperature annealing treatment, the precipitate is obtained to prepare the silicon dioxide/carbon composite material. Subsequently, the carbon is removed by calcination in the air to prepare hollow porous silica microspheres. Step 2. The hollow porous silica microspheres prepared in Step 1 were used as the silicon source, cobalt acetylacetone was used as the cobalt source, and N,N-dimethylformamide was used as the reaction solvent to carry out hydrothermal reactions, and the solid-phase reactants were obtained independently after the reaction, and the hollow porous silica/cobalt composites were prepared by washing and drying. The hollow porous silica/cobalt composites prepared by this method are stable albeit It is better, but its capacity is low, and there are many synthesis steps, and it is not easy to operate.

CN111129440A discloses a silicon dioxide-carbon composite material and its preparation method and application in the negative electrode material of lithium-ion batteries. The main synthesis method is as follows: Step 1. Carbon framework is treated with a mixed acid of concentrated sulfuric acid and concentrated nitric acid, resulting in oxygen-containing functional groups on the surface of the carbon framework. Step 2. A mixed solution of ammonia water, deionized water, and tetraethyl orthosilicate is prepared, and the obtained product is further reduced under an inert atmosphere to prepare the silicon dioxide-carbon composite material.

CN110611092A discloses a method for preparing a nanoscale silicon dioxide/porous carbon lithium-ion battery negative electrode material. The specific synthesis method is as follows: Step 1. Metal oxide (such as aluminum oxide, titanium dioxide, or copper oxide powder) is used as a template, and then treated with a silicon source (such as methyltrimethoxysilane, aminoethyltrimethoxysilane, trimethylmethoxysilane, or phenyltrimethoxysilane) to prepare a silicon-containing precursor. Step 2. The silicon-containing precursor is coated with polyvinylpyrrolidone (PVP) (or carboxymethyl cellulose CMC, or styrene butadiene rubber SBR) in a solvent such as water or N-methylpyrrolidone (NMP) or tetrahydrofuran (THF). After removing the solvent, the precursor is obtained. Step 3. The obtained precursor is further reduced by magnesiothermic reduction or hydrogen gas thermal reduction to prepare the silicon negative electrode material coated with hollow carbon. The material exhibits good capacity at a mass current density of 1 A/g, but it shows low first-cycle charge/discharge efficiency.

U.S. Pat. No. 10,637,048B2 discloses a method for preparing silicon negative electrode material. The specific synthesis steps are as follows: Step 1. Silicon oxide particles and silicon nanoparticles with particle sizes ranging from 10 to 500 nm and 2 to 200 nm, respectively, are used as raw materials to synthesize silicon-containing precursors, along with polyethylene glycol (PEG). Step 2. The silicon-containing precursor obtained in step 1 is enveloped with polyvinylpyrrolidone (PVP) in a solvent such as water or N-methyl-2-pyrrolidone (NMP) or tetrahydrofuran (THF). Step 3. The product obtained in step 2 is further reduced using magnesiothermic reduction or hydrogen gas thermal reduction, resulting in the preparation of hollow carbon-coated silicon negative electrode material. While the negative electrode material mitigates the volume expansion of silicon to some extent by utilizing the hollow structure of carbon, its rate performance and stability in lithium-ion batteries are relatively poor.

U.S. Pat. No. 10,541,411B2 discloses a negative electrode material for energy storage devices. The specific synthesis steps are as follows: Silicon nanoparticles are dispersed in an ethanol solution containing one or more metal elements such as Al, Zr, Mg, Ca, or containing one or more substances such as ethylene glycol, propylene glycol, and polyvinyl alcohol. Subsequently, the mixture is heated to prepare negative electrode material with silicon surface covered by oxides. This method is simple to operate, cost-effective, and suitable for large-scale production. However, the prepared material exhibits poor performance and stability in charge/discharge.

Yang et al. reported a method for synthesizing mutually cross-linked and stretchable carbon-coated silicon nanoparticles in the journal National Science Review (doi:10.1093/nsr/nwab012). The specific synthesis steps are as follows: Step 1. Silicon with particle sizes ranging from 3 to 5 μm is used as the silicon source. Methane gas is converted into carbon, encapsulating the silicon spheres using chemical vapor deposition (CVD). Step 2. The carbon-coated silicon spheres prepared in step 1 are further etched with strong base sodium hydroxide to enrich the material with more pore structures (SiMP@C). Step 3. The SiMP@C obtained in step 2 is subjected to a hydrothermal experiment with graphene oxide, and the shrinkage of graphene oxide material using capillary drying principle results in the preparation of stretchable graphene oxide layers (SiMP@C-GN). This material exhibits high cycling activity in half lithium-ion batteries and high volumetric energy density in full batteries. However, the use of hazardous gases (chemicals) such as methane and sodium hydroxide in the operation process increases production costs and operational difficulties. Additionally, the large volume of silicon spheres hinders contact with the electrolyte.

Yang et al. reported a method for uniformly coating silica nanoparticles with carbon layers in the journal Angewandte Chemie International Edition (doi:10.1002/anie.201902083). The specific synthesis steps are as follows: Step 1. 1,4-Bis(triethoxysilyl)benzene (BTEB) is used as the silicon source, and sol-gel method is employed to convert BTEB into silica nanoparticles. Step 2. The silica nanoparticles containing silicon are further carbonized at high temperature to prepare carbon-coated silica negative electrode materials on an atomic level. This material exhibits a first-cycle discharge capacity of 1380 mAh/g at a mass current density of 0.5 A/g, and still retains a capacity of 501 mAh/g after 300 cycles, showing good capacity and cycling performance. However, the high cost and complexity of the material synthesis hinder large-scale production.

In summary, many existing technologies have disclosed the synthesis and preparation of silicon (or silica)/carbon composite lithium-ion battery negative electrode materials, which demonstrate performance superior to graphite negative electrode materials. However, the synthesis methods for such silicon (or silica)/carbon materials are generally complex, with strict synthesis conditions, making them unsuitable for large-scale production. Additionally, the failure to confine the silicon (or silica) leads to pulverization of silicon (or silica) during charge and discharge processes, thereby requiring improvement in the overall performance of the materials.

Based on the above reasons, the development of a green, environmentally friendly, relatively simple process, and high-performance confined silicon/carbon material remains of significant importance. Moreover, this is also a hotspot in the field of lithium-ion battery negative electrode materials, and it is the basis and driving force for the completion of this invention.

### SUMMARY

In order to develop novel silicon/carbon materials, particularly confined silicon composite carbon materials, the inventors conducted in-depth research and made significant creative contributions, ultimately leading to the completion of this invention.

Specifically, the technical solution and content of this invention involve a method for synthesizing confined silicon/multi-walled carbon nanotube composite materials for lithium-ion battery negative electrodes and a preparation method for lithium-ion battery negative electrode materials using these materials.

More specifically, this invention involves several aspects:

Firstly, it relates to a method for synthesizing confined silicon/multi-walled carbon nanotube composite materials for lithium-ion battery negative electrodes. The method includes the following steps:
S1: Dispersion of multi-walled carbon nanotubes in methyl-substituted benzene solvent, followed by sonication at room temperature for 10 minutes to obtain a multi-walled carbon nanotube/methyl-substituted benzene suspension;
S2: Addition of liquid silicon precursor to the suspension obtained in step S1 after sonication, followed by continued sonication at room temperature for 10 minutes to obtain a mixture;
S3: Heating the mixture obtained in step S2 under oil bath reflux; and
S4: Upon completion of the reaction, natural cooling to room temperature, centrifugation, washing, and drying to obtain confined silica/multi-walled carbon nanotube composite material.

In the preparation method of the confined silicon/multi-walled carbon nanotubes in this invention, in step SI, the methyl-substituted benzene solvent may be a single or multiple methyl-substituted benzene series organic compounds, such as toluene, ortho-xylene, meta-xylene, or a mixed xylene solvent, with the optimal choice being a xylene solvent.

In the preparation method of the confined silicon/multi-walled carbon nanotubes in this invention, in step SI, the multi-walled carbon nanotubes may be surface-modified or untreated, such as carboxylated multi-walled carbon nanotubes, aminated multi-walled carbon nanotubes, and surface untreated multi-walled carbon nanotubes, with the optimal choice being surface untreated multi-walled carbon nanotubes.

In the preparation method of the confined silicon/multi-walled carbon nanotubes in this invention, in step SI, the solvent volume is 3˜6 mL, with the optimal choice being 6 mL.

In the preparation method of the confined silicon/multi-walled carbon nanotubes in this invention, in step S2, the silicon precursor is silicon-containing chlorosilane, such as silicon tetrachloride (SiCl4), trichlorosilane (SiHCl₃), dichlorosilane (Si₂H₂Cl₂), or hexachloroethane (Si₂Cle), with the optimal choice being liquid silicon tetrachloride.

In the preparation method of the confined silicon/multi-walled carbon nanotubes in this invention, in step S2, the mass ratio of multi-walled carbon nanotubes to silicon precursor is 1:1˜3.

In the preparation method of the confined silicon/multi-walled carbon nanotubes in this invention, in step S3, the temperature of the oil bath reflux treatment is 110-150° C., and when the reflux solvent is a mixed xylene, the preferred temperature is 145° C.

In the preparation method of the confined silicon/multi-walled carbon nanotubes in this invention, in step S3, the oil bath time is 6-10 h, for example, it can be 6 h, 8 h, and 10 h, with the optimal being 8 h.

In the preparation method of the confined silicon/multi-walled carbon nanotubes in this invention, in step S4, the centrifugation speed is 10000˜21000 rpm, with the optimal being 15000 rpm.

The inventors found that by using the above preparation method of this invention, especially with certain preferred process parameters, excellent electrical properties of confined silicon/multi-walled carbon nanotubes can be obtained. Lithium-ion battery negative electrodes made from these materials exhibit outstanding performance, such as high capacity and stability, thereby making them suitable for lithium-ion negative electrodes.

The second aspect of the present invention involves the confined silicon/multi-walled carbon nanotube composite material obtained through the above preparation method.

The confined silicon/multi-walled carbon nanotube composite material exhibits excellent properties, featuring the one-dimensional morphology of multi-walled carbon nanotubes. Lithium-ion negative electrode materials made from this composite material exhibit outstanding electrochemical performance, such as high capacity and stability, making them suitable for lithium-ion negative electrodes.

The third aspect of the present invention involves a lithium-ion negative electrode including the confined silicon/multi-walled carbon nanotube composite material.

The fourth aspect of the present invention involves a method for preparing the lithium-ion negative electrode, including the following steps:
A. In a dry environment, pour the confined silicon/multi-walled carbon nanotube composite material, acetylene black, and PVDF into an agate mortar in a mass ratio of 7:1:2, respectively. Wherein acetylene black serves as a conductive agent to enhance the electrode's conductivity, and PVDF serves as a binder to prevent electrode detachment or cracking.
B. After the three solid components are evenly mixed, add a small amount of N-methyl-2-pyrrolidone (NMP) as a solvent and grind the material until it forms a black viscous paste. Adjust the height of the coater to control the loading amount of the electrode, then use the coater to evenly coat the slurry onto the copper foil current collector.
C. Place the copper foil in a vacuum drying oven at 80° C. for drying. Remove the material, use a cutting machine to cut the copper foil coated with the confined silicon/multi-walled carbon nanotube composite material into circular pieces as electrode sheets, weigh and record the weight of the material, with an active material loading of approximately 3 mg/cm². Transfer the electrode sheets to a glove box for battery assembly.

In the preparation method of the oxygen reduction electrode described in the present invention, in step A, the mass ratio between the confined silicon/multi-walled carbon nanotube composite material, acetylene black, and PVDF can be 7:1:2, 7:1.5:1.5, or 7:2:1.

In the preparation method of the oxygen reduction electrode described in the present invention, in step A or B, the NMP serves as an ultra-dry solvent.

In the preparation method of the oxygen reduction electrode described in the present invention, in step A or B, the amount of NMP is not specifically defined, and those skilled in the art can make appropriate choices, such as adding NMP solvent to the slurry to achieve a liquid-like consistency.

The fifth aspect of the present invention involves the use of the confined silicon/multi-walled carbon nanotube composite material in lithium-ion full batteries.

As mentioned above, due to its various excellent electrochemical properties, the lithium-ion negative electrode material can be applied to lithium-ion full batteries, thereby obtaining lithium-ion batteries with excellent performance.

As described above, the present invention provides a method for synthesizing confined silicon/multi-walled carbon nanotube composite material for lithium-ion battery negative electrodes and a method for preparing lithium-ion battery negative electrode materials using the confined silicon/multi-walled carbon nanotube composite material. The confined silicon/multi-walled carbon nanotube composite material exhibits excellent performance and can be used to prepare negative electrode materials for lithium-ion batteries, thereby being applicable to lithium-ion full batteries. It exhibits good electrochemical properties, indicating significant potential and industrial value in the field of electrochemistry.

### BRIEF DESCRIPTION OF THE DRAWINGS

FIG. 1 shows the thermogravimetric analysis (TGA) curve of the limited silica/multi-walled carbon nanotubes synthesized with different organic solvents (toluene and xylene) in Example 1 of the present invention.

FIG. 2 depicts the TGA curves of the limited silica/multi-walled carbon nanotubes obtained with different mass ratios of silicon tetrachloride to multi-walled carbon nanotubes in Example 2 of the present invention.

FIG. 3 illustrates the TGA curves of the silica composite carbon nanotube materials prepared using carboxylated multi-walled carbon nanotubes and aminated multi-walled carbon nanotubes in Example 3 of the present invention.

FIGS. 4A-4B display the high-resolution transmission electron microscopy (HRTEM) images of the silica composite carbon nanotube materials obtained in Examples 1 and 3 of the present invention.

FIGS. 5A-5D show the energy dispersive X-ray spectroscopy (EDS) elemental mapping of the limited silica/multi-walled carbon nanotubes in Example 1 of the present invention.

FIGS. 6A-6D present the X-ray photoelectron spectroscopy (XPS) spectra of the limited silica/multi-walled carbon nanotubes in Example 1 of the present invention.

FIG. 7 exhibits the X-ray diffraction (XRD) patterns of the limited silica/multi-walled carbon nanotubes in Example 1 of the present invention.

FIG. 8 illustrates the electrochemical impedance spectroscopy (EIS) plots of the limited silica/multi-walled carbon nanotubes in Example 1 of the present invention.

FIGS. 9A-9D demonstrate the battery performance of the limited silica/multi-walled carbon nanotubes as the negative electrode in a lithium-ion battery in Example 1 of the present invention.

FIGS. 10A-10D present relevant data plots, including TGA, EIS, cycling discharge curves, and rate performance curves, of the limited silica/multi-walled carbon nanotubes prepared using trichlorosilane as the silicon source in Example 4 of the present invention.

### DETAILED DESCRIPTION OF THE EMBODIMENTS

The present invention is described in detail below through specific drawings and embodiments, but the use and purpose of these illustrative drawings and embodiments are only used to exemplify the present invention and do not constitute any form of limitation to the actual protection scope of the present invention, let alone limit the protection scope of the present invention.

### EXAMPLE 1

### Investigation of the Influence of Different Reaction Solvents on the Silicon Dioxide Content

S1: Disperse multi-walled carbon nanotubes (MWCNTs) in toluene or xylene solvent and sonicate for 10 minutes at room temperature.
S2: After sonication, add liquid silicon tetrachloride (SiCl₄) to the MWCNT/toluene or MWCNT/xylene suspension and continue sonication for another 10 minutes at room temperature.
S3: Heat the above mixture in an oil bath to 115 or 145° C. and perform reflux.
S4: After the reaction, cool the mixture to room temperature, centrifuge, wash, and dry the resulting solid to obtain dried samples, thus obtaining the limited silicon dioxide/MWCNT composite materials, designated as MWCNT/SiO₂-toluene and MWCNT/SiO₂-xylene, respectively.

### EXAMPLE 2

### Screening of the Mass Ratio of Silicon Tetrachloride to Multi-Walled Carbon Nanotubes

S1: Disperse multi-walled carbon nanotubes in xylene solvent and sonicate for 10 minutes at room temperature.
S2: After sonication, add liquid silicon tetrachloride to the MWCNT/xylene suspension at different mass ratios of carbon nanotubes to silicon tetrachloride, namely 1:1, 1:2, and 1:3, and continue sonication for another 10 minutes at room temperature.
S3: Heat the above mixture in an oil bath to 145° C. and perform reflux.
S4: After the reaction, cool the mixture to room temperature, centrifuge, wash, and dry the resulting solid to obtain dried samples, thus obtaining different limited silicon dioxide/MWCNT composite materials designated as MWCNT/SiO₂-0.05, MWCNT/SiO₂-0.1, and MWCNT/SiO₂-0.15.

### EXAMPLE 3

### Screening of the Influence of Different Functional Group-Modified Multi-Walled Carbon Nanotubes on Limited Silicon Dioxide

S1: Disperse carboxylated or aminated multi-walled carbon nanotubes in xylene solvent and sonicate for 10 minutes at room temperature.
S2: After sonication, add liquid silicon tetrachloride to the carboxylated or aminated MWCNT/xylene suspension at a mass ratio of carbon nanotubes to silicon tetrachloride of 1:2, and continue sonication for another 10 minutes at room temperature.
S3: Heat the above mixture in an oil bath to 145° C. and perform reflux.
S4: After the reaction, cool the mixture to room temperature, centrifuge, wash, and dry the resulting solid to obtain dried samples, thus obtaining different limited silicon dioxide/MWCNT composite materials designated as H₂N-MWCNT/SiO₂ and HOOC-MWCNT/SiO₂.

### EXAMPLE 4

### Screening of the Performance Influence of Different Silicon Sources on Limited Silicon Dioxide/Multi-Walled Carbon Nanotubes

S1: Disperse multi-walled carbon nanotubes in xylene solvent and sonicate for 10 minutes at room temperature.
S2: After sonication, add liquid trichlorosilane to the MWCNT/xylene suspension at a mass ratio of carbon nanotubes to trichlorosilane of 1:2, and continue sonication for another 10 minutes at room temperature.
S3: Heat the above mixture in an oil bath to 145° C. and perform reflux.
S4: After the reaction, cool the mixture to room temperature, centrifuge, wash, and dry the resulting solid to obtain dried samples, thus obtaining MWCNT/SiO₂-SiCH₃.

### EXAMPLE 5

### Assembly of Lithium-Ion Half-Cell Using MWCNT/SiO₂-xylene as the Lithium-Ion Negative Electrode Material

S1: In a dry environment, pour the limited silicon dioxide/MWCNT composite materials (MWCNT/SiO₂-xylene and MWCNT/SiO₂-SiCHCl₃), acetylene black, and PVDF into an agate mortar at a mass ratio of 7:1:2, respectively. Where acetylene black serves as a conductive agent to enhance the electrode's conductivity, and polyvinylidene fluoride (PVDF) acts as a binder to prevent electrode detachment or cracking.
S2: After thoroughly mixing the three solids, add a small amount of N-methyl-2-pyrrolidone (NMP) as a solvent and grind the material until it forms a black, viscous paste. Adjust the height of the coating machine to control the electrode's loading amount, and then evenly coat the paste onto the copper foil current collector using the coating machine.
S3: Dry the copper foil in a vacuum drying oven at 80° C. Remove the material, use a slitter to cut the copper foil coated with the limited silicon dioxide/MWCNT composite material into round pieces as electrode sheets, weigh, and record the weight of the material. The loading amount of active material is approximately 3 mg/cm². Transfer the electrode sheets to a glove box for battery assembly.

### EXAMPLE 6

### Assembly of Lithium-Ion Half-Cell Using MWCNT/SiO₂-SiCHCl₃ as the Lithium-Ion Negative Electrode Material

S1: In a dry environment, pour the limited silicon dioxide/MWCNT composite material (MWCNT/SiO₂-SiCHCl₃), acetylene black, and PVDF into an agate mortar at a mass ratio of 7:1:2, respectively. Where acetylene black serves as a conductive agent to enhance the electrode's conductivity, and polyvinylidene fluoride (PVDF) acts as a binder to prevent electrode detachment or cracking.
S2: After thoroughly mixing the three solids, add a small amount of N-methyl-2-pyrrolidone (NMP) as a solvent and grind the material until it forms a black, viscous paste. Adjust the height of the coating machine to control the electrode's loading amount, and then evenly coat the paste onto the copper foil current collector using the coating machine.
S3: Dry the copper foil in a vacuum drying oven at 80° C. Remove the material, use a slitter to cut the copper foil coated with the limited silicon dioxide/MWCNT composite material into round pieces as electrode sheets, weigh, and record the weight of the material. The loading amount of active material is approximately 3 mg/cm². Transfer the electrode sheets to a glove box for battery assembly.

### Microscopic Characterization and Electrochemical Performance Tests

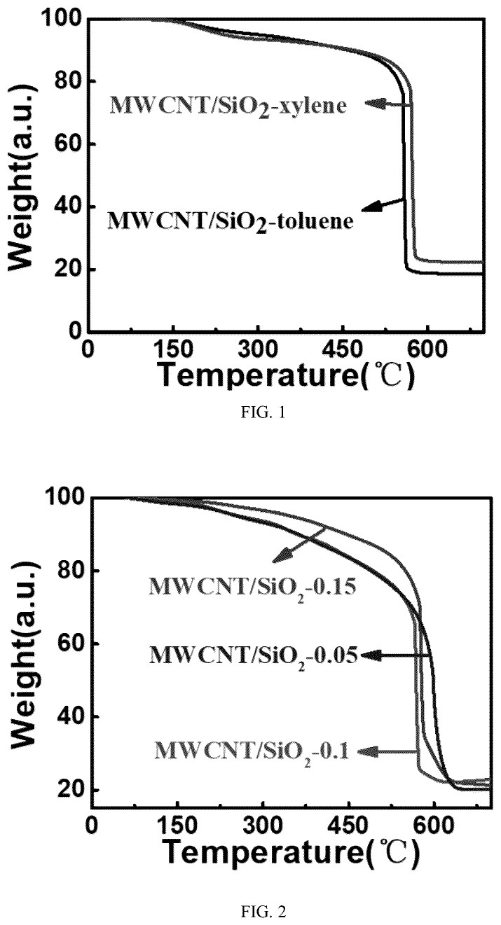

The tests were conducted on the limited silicon dioxide/carbon nanotube (MWCNT/SiO₂-toluene and MWCNT/SiO₂-xylene) obtained in Example 1. Thermal characterization was performed, and from FIG. 1, it is observed that when xylene is used as the reaction solvent, MWCNT/SiO₂-xylene exhibits a higher silicon dioxide loading, approximately 23%. The difference in silicon dioxide loading may be attributed to the difference in reflux temperature caused by different solvents. Therefore, xylene is chosen as the optimal reaction solvent.

Thermal gravimetric characterization was performed on silica/carbon nanotube composites with different ratios of tetraethyl orthosilicate (TEOS) and unmodified multi-walled carbon nanotubes (MWCNTs) obtained from Example 2. As shown in FIG. 2, when the mass ratio was 1:1, the silica content was 19%, while it increased to 23% when the mass ratio was 1:2. However, upon further increase to 1:3, the silica content did not change significantly, remaining approximately 23%. This may indicate that the limited internal pores of multi-walled carbon nanotubes cannot accommodate more silica.

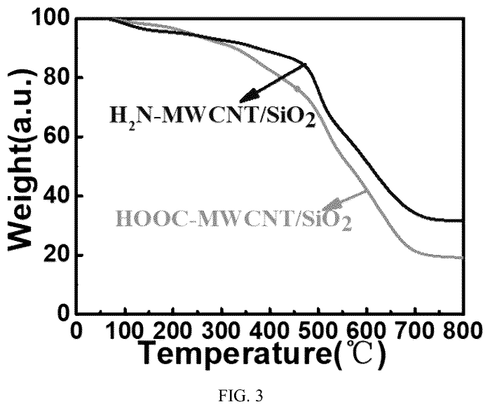

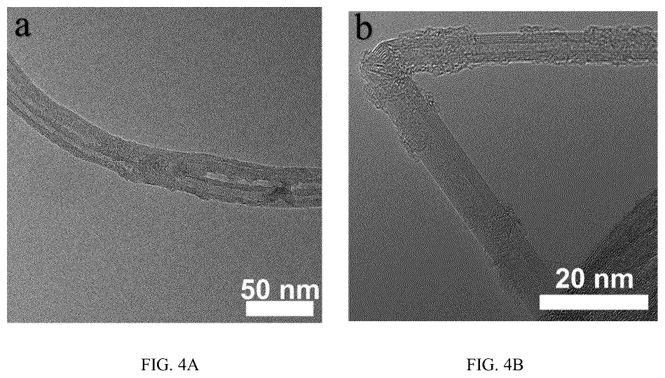

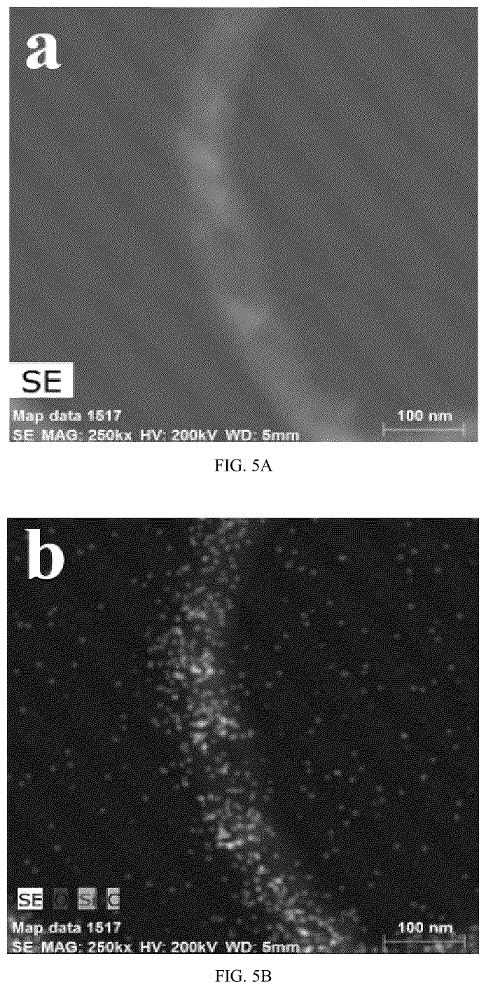

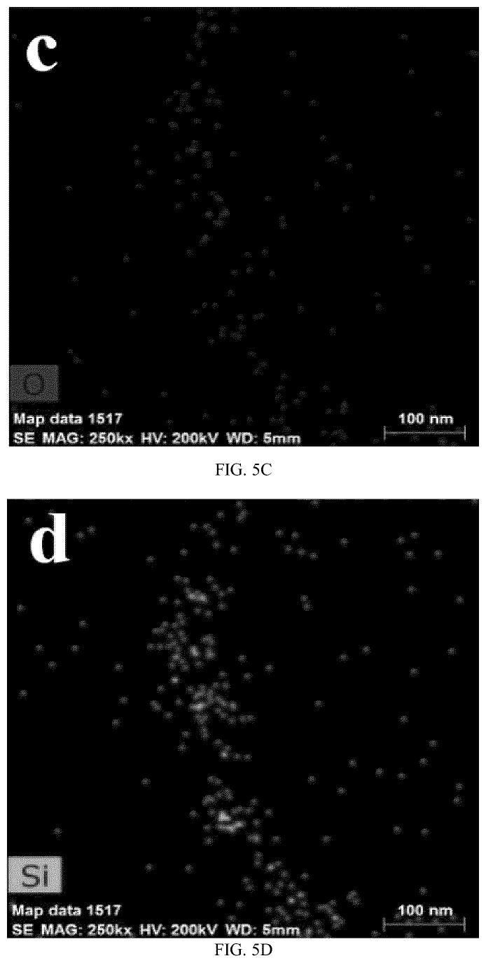

Transmission electron microscopy (TEM) and thermal gravimetric analysis (TGA) were conducted on silica-composite surfaces modified or unmodified with multi-walled carbon nanotubes obtained from Example 1 and Example 2. As depicted in FIG. 3, when carboxylated or aminated multi-walled carbon nanotubes were used as carriers, the silica loading was 19% and 32%, respectively. Further analysis in FIGS. 4A-4B reveals that although the silica loading on aminated multi-walled carbon nanotubes is higher, TEM results indicate the presence of silica loaded on the surface of aminated multi-walled carbon nanotubes, while unmodified multi-walled carbon nanotubes show no apparent silica on their surface. FIGS. 5A-5D further demonstrate the uniform dispersion of silica within unmodified multi-walled carbon nanotubes, indicating effective confinement of silica within the interior of the multi-walled carbon nanotubes.

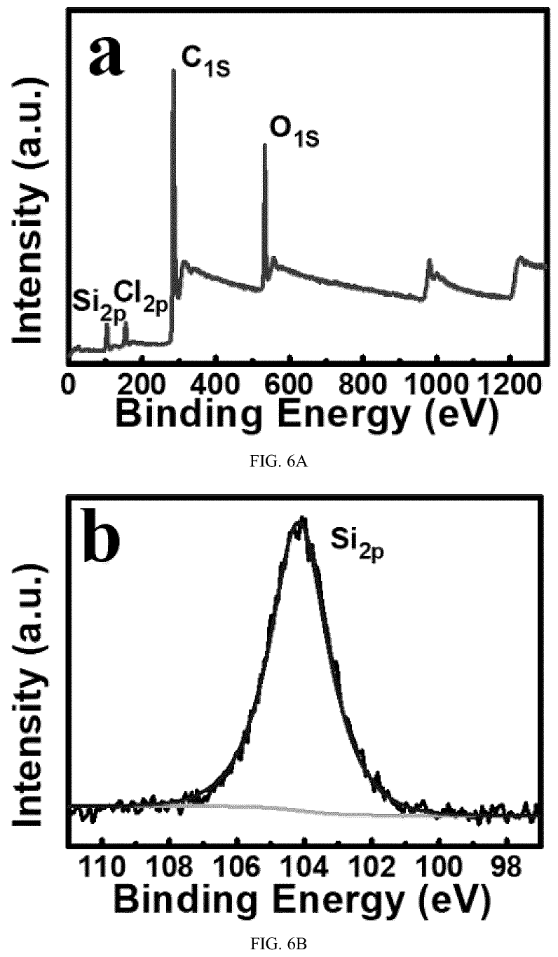

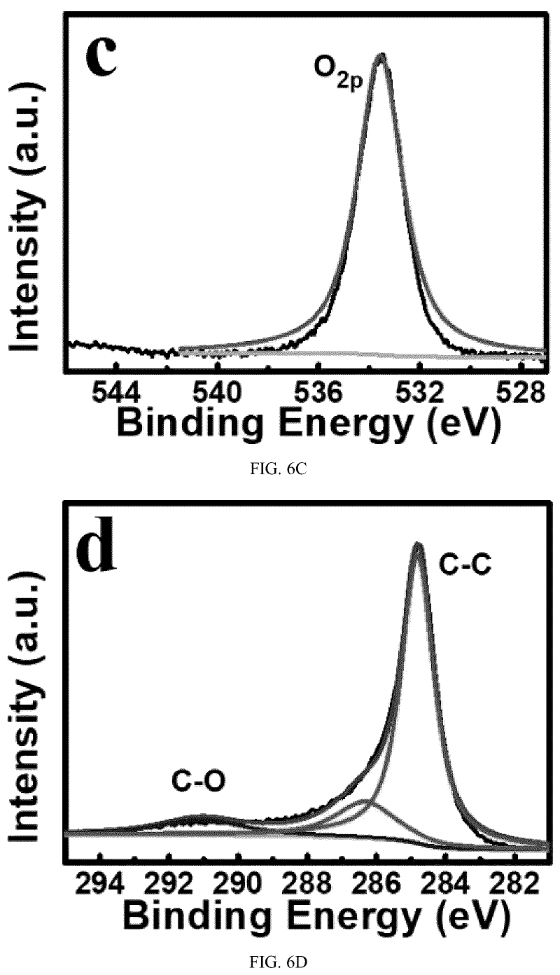

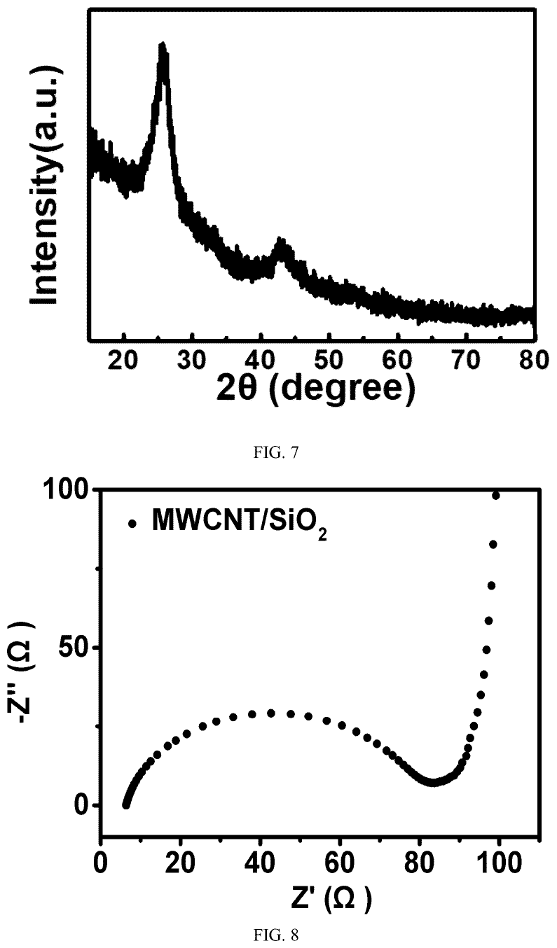

X-ray photoelectron spectroscopy (XPS) and X-ray diffraction (XRD) were performed on MWCNT/SiO₂-xylene obtained from Example 1, as shown in FIGS. 6A-6D. The material mainly consists of four elements: C, O, Si, and Cl, with respective contents of 73.52%, 17.63%, 7.17%, and traces of Cl. The Si2p peak at 104.1 eV and the O2p peak at 533.5 eV correspond to the characteristic peaks of SiO₂, suggesting the presence of silicon dioxide as an active substance in the material. However, as shown in FIG. 7, the XRD spectrum of MWCNT/SiO₂-xylene only exhibits characteristic peaks of carbon nanotubes near 26° and 40°, with no discernible peaks of SiO₂. This is likely due to the complete encapsulation of SiO₂ by carbon nanotubes or the low external content of SiO₂ on carbon nanotubes.

Electrochemical impedance spectroscopy (EIS) was conducted on MWCNT/SiO₂-xylene obtained from Example 5, as shown in FIG. 8. Upon assembly into a lithium-ion battery, the resistance of MWCNT/SiO₂ was approximately 90Ω, indicating strong conductivity of the material. This is attributed to the presence of numerous carbon nanotubes in the material, which form a conductive network for electron and lithium-ion transport, thereby enhancing the material's conductivity.

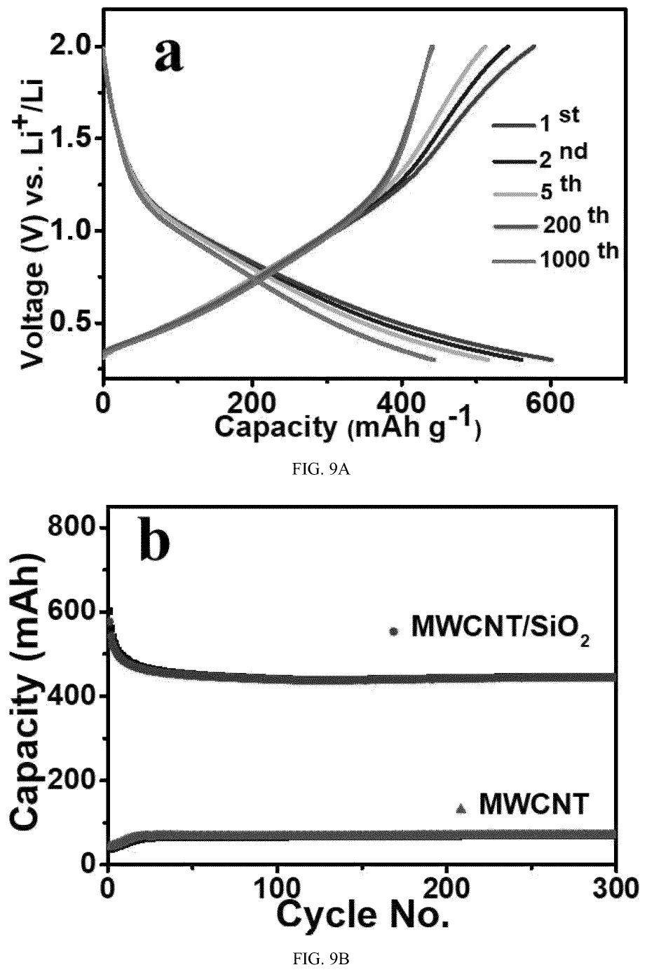

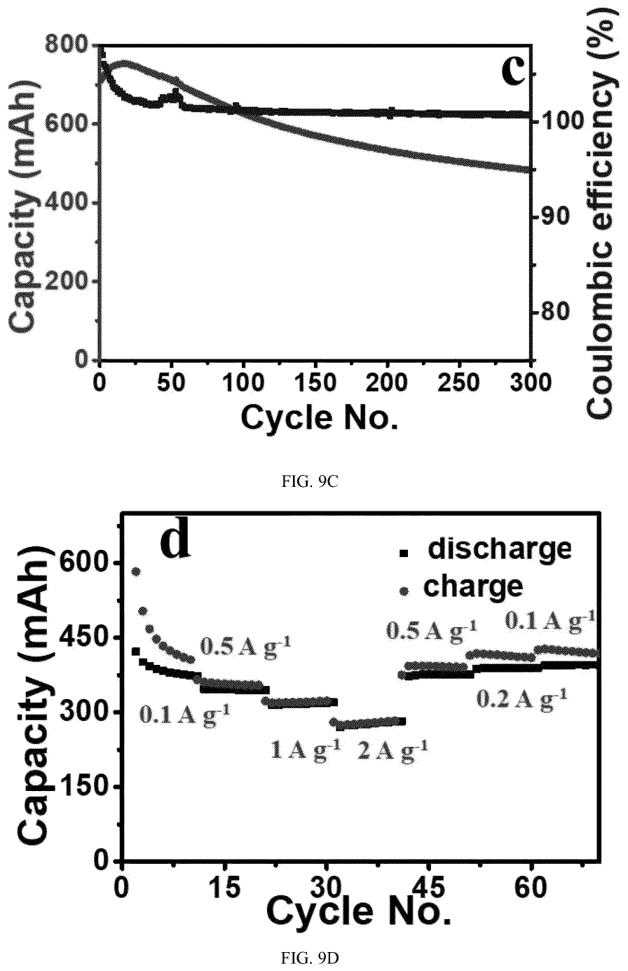

The lithium-ion battery performance of MWCNT/SiO₂-xylene obtained from Example 5 was tested. As shown in FIG. 9A, the charge-discharge curve of the battery at a current density of 0.1 A/g is illustrated. The initial discharge capacity of the battery reached 600 mAh/g, which decreased to 515 mAh/g after undergoing five cycles of lithiation and delithiation. However, even after cycling for 200 or 2000 cycles, the specific capacity of MWCNT/SiO₂ remained at approximately 425 mAh/g, demonstrating remarkable stability with minimal degradation over prolonged cycling. The material exhibited rapid capacity decay in the initial cycles, likely due to the unique properties of silica, which requires prior reaction with lithium ions to form silicon before contributing to capacity. During the initial cycles, SiO₂ generates a significant amount of by-products such as Li₂O and Li₄SiO₄ during its reaction with lithium ions, resulting in high irreversible capacity in the early cycles. However, once SiO₂ is fully converted to silicon, the material's capacity stabilizes due to complete encapsulation of the carbon nanotubes, resulting in stable capacity. FIGS. 9B-9D indicate that under a current density of 0.1 A/g, the capacity of MWCNT/SiO₂-xylene remains stable at around 420 mAh/g, significantly higher than that of multi-walled carbon nanotubes. When the current density is increased to 1 A/g, the initial specific capacity drops to 421 mAh/g, decreasing to 365 mAh/g after 300 cycles. Despite the decrease in capacity with increasing rates, the battery still exhibits excellent cycling performance, indicating the structural stability of the material, which remains unaffected even at higher current rates.

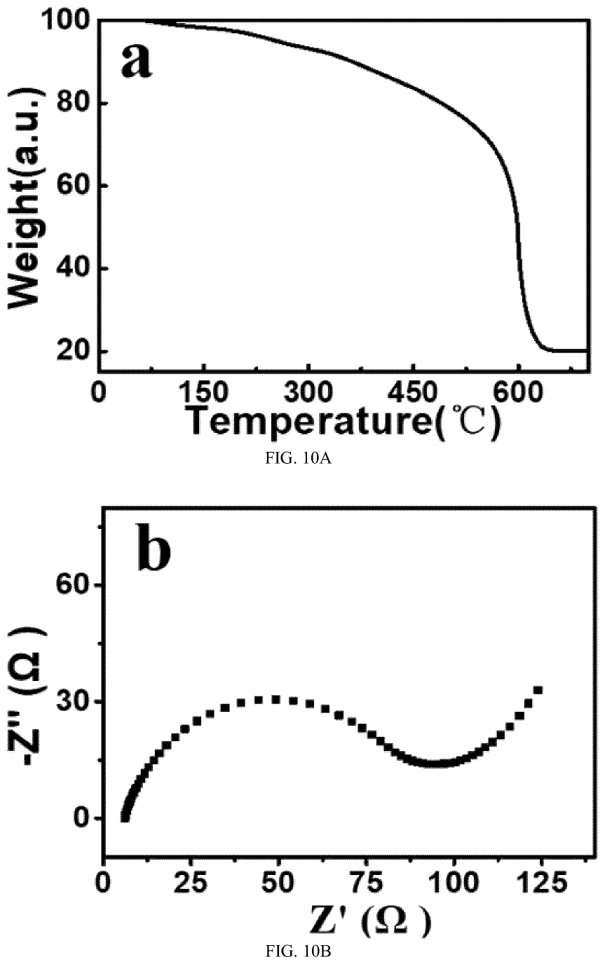

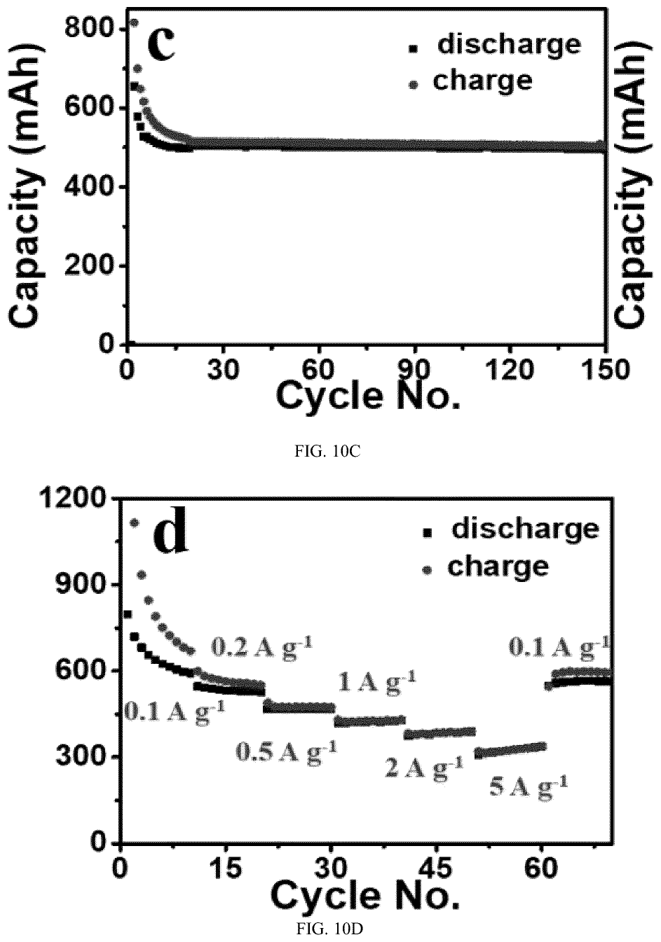

The lithium-ion battery performance of MWCNT/SiO₂-SiCHCl₃ obtained from Example 6 was also evaluated. As depicted in FIG. 10A, the silica content is approximately 20%, similar to that of MWCNT/SiO₂-xylene. However, MWCNT/SiO₂-SiCHCl₃ exhibits slightly higher resistance, approximately 100Ω (FIG. 10B). FIGS. 10C-10D illustrate the initial discharge capacity of 816 mAh/g under a current density of 0.1 A/g, which drops to 500 mAh/g within the first 20 cycles. Subsequently, the capacity curve becomes stable, and the discharge specific capacity stabilizes at 502 mAh/g. After cycling for 150 cycles, the battery exhibits almost no capacity loss in the subsequent 100 cycles, indicating excellent stability. Observing its rate performance, at a current density of 0.1 A/g, the initial capacity is 1115 mAh/g, which rapidly decreases to approximately 600 mAh/g after the initial cycles. Additionally, at a current density of 0.2 A/g, noticeable capacity decay is observed due to the formation of the solid electrolyte interphase (SEI) film. As the current gradually increases, the capacity declines to 320 mAh/g. However, when the current density returns to its initial value, the capacity recovers to 595 mAh/g, demonstrating the material's ability to recover even after experiencing high-current charge-discharge cycles, thus exhibiting excellent stability.

The physical and chemical properties characterization of the silica/carbon nanotube composite materials obtained from Examples 1-4 are highly similar to MWCNT/SiO₂-xylene (with only experimental measurement errors present). Therefore, given their highly similar nature, individual spectra are not further delineated.

As described above, the present invention provides a synthetic method for the preparation of confined silica/multi-walled carbon nanotube composite materials for use as negative electrodes in lithium-ion batteries, as well as a method for preparing negative electrode materials for lithium-ion batteries using said composite materials. The composite materials possess the one-dimensional morphology of carbon nanotubes, with silica particles effectively confined within the multi-walled carbon nanotubes. The issue of poor conductivity of silica, due to its tight contact with multi-walled carbon nanotubes, is effectively mitigated. Silica is effectively embedded within multi-walled carbon nanotubes, thereby limiting the volume expansion of silica to a certain extent during charge and discharge processes. Overall, MWCNT/SiO₂-xylene exhibits excellent rate performance and charge-discharge stability. Furthermore, the process is simple, with low costs for drugs and reagents. Finally, the process has minimal environmental pollution, making it a green and environmentally friendly process. In conclusion, this material can be used to prepare negative electrode materials for lithium-ion batteries, demonstrating excellent electrochemical performance and possessing promising prospects and industrial potential in the field of electrochemical energy storage.

It should be understood that the use of these examples is intended only to illustrate the present invention and not to limit the scope of the invention. Additionally, it should be understood that after reading the technical content of the present invention, those skilled in the art may make various changes, modifications, and/or variations to the present invention, all of which fall within the scope of protection defined by the appended claims of this application.

What is claimed is:

1. A method for preparing a confined silica/multi-walled carbon nanotube composite material, comprising the following steps:
S1: dispersing multi-walled carbon nanotubes in a methyl-substituted benzene solvent, followed by sonication at a room temperature for 10 minutes to obtain a multi-walled carbon nanotube/methyl-substituted benzene suspension;
S2: Addition of adding g a liquid silicon precursor to the multi-walled carbon nanotube/methyl-substituted benzene suspension obtained in step S1 after sonication, followed by continued sonication at the room temperature for 10 minutes to obtain a mixture;
S3: heating the mixture obtained in step S2 under an oil bath reflux to allow a reaction; and
S4: upon completion of the reaction, naturally cooling the mixture to the room temperature, and performing centrifugation, washing and drying to obtain the confined silica/multi-walled carbon nanotube composite material.

2. The method according to claim 1, wherein in step S1, the methyl-substituted benzene solvent is a single or multiple methyl-substituted benzene organic compound.

3. The method according to claim 1, wherein in step S1, the multi-walled carbon nanotubes are surface-modified or untreated.

4. The method according to claim 1, wherein in step S2, the silicon precursor is a silicon-chlorine silane, and the silicon-chlorine silane is tetrachlorosilane, trichlorosilane, dichlorosilane, or hexachlorodisilane, or a combination thereof.

5. The method according to claim 1, wherein the oil bath reflux in step S3 is performed at 110° C.-150° C.

6. The method according to claim 1, wherein a volume of the methyl-substituted benzene solvent in step S1 is 3 mL-6 mL.

7. The method according to claim 1, wherein a mass ratio of the multi-walled carbon nanotubes to the silicon precursor in step S2 is 1:1 to 3.

8. A confined silica/multi-walled carbon nanotube composite material prepared by the method according to claim 1.

9. A lithium-ion negative electrode material, comprising the confined silica/multi-walled carbon nanotube composite material according to claim 8.

10. The lithium-ion negative electrode material according to claim 9, wherein a mass ratio of the confined silica/multi-walled carbon nanotubes, acetylene black, and polyvinylidene fluoride (PVDF) is 7:(1-2):(1-2).

11. The method according to claim 2, wherein in step S1, the multi-walled carbon nanotubes are surface-modified or untreated.

12. The method according to claim 2, wherein in step S2, the silicon precursor is a silicon-chlorine silane, and the silicon-chlorine silane is tetrachlorosilane, trichlorosilane, dichlorosilane, or hexachlorodisilane, or a combination thereof.

13. The method according to claim 2, wherein the oil bath reflux in step S3 is performed at 110° C.-150° C.

14. The method according to claim 2, wherein a volume of the methyl-substituted benzene solvent in step S1 is 3 mL-6 mL.

15. The method according to claim 2, wherein a mass ratio of the multi-walled carbon nanotubes to the silicon precursor in step S2 is 1:1 to 3.

16. The confined silica/multi-walled carbon nanotube composite material according to claim 8, wherein in step S1 of the method, the methyl-substituted benzene solvent is a single or multiple methyl-substituted benzene organic compound.

17. The confined silica/multi-walled carbon nanotube composite material according to claim 8, wherein in step S1 of the method, the multi-walled carbon nanotubes are surface-modified or untreated.

18. The confined silica/multi-walled carbon nanotube composite material according to claim 8, wherein in step S2 of the method, the silicon precursor is a silicon-chlorine silane, and the silicon-chlorine silane is tetrachlorosilane, trichlorosilane, dichlorosilane, or hexachlorodisilane, or a combination thereof.

19. The confined silica/multi-walled carbon nanotube composite material according to claim 8, wherein in the method, the oil bath reflux in step S3 is performed at 110° C.-150° C.

20. The confined silica/multi-walled carbon nanotube composite material according to claim 8, wherein in the method, a volume of the methyl-substituted benzene solvent in step S1 is 3 mL-6 mL.
